(19) United States
(12) Patent Application Publication
(10) Pub. No.: US 2014/0136220 A1
(43) Pub. Date: May 15, 2014

(54) Interactive Patient and Physician Systems and Their Methods of Use

(71) Applicants: Alan Rapoport, Los Angeles, CA (US); Robert Cowan, Stanford, CA (US)

(72) Inventors: Alan Rapoport, Los Angeles, CA (US); Robert Cowan, Stanford, CA (US)

(21) Appl. No.: 14/016,489

(22) Filed: Sep. 3, 2013

Related U.S. Application Data
(60) Provisional application No. 61/696,153, filed on Sep. 1, 2012.

(51) Int. Cl. G06F 19/00

(52) U.S. Cl. CPC G06F 19/3431
USPC 705/2

(57) ABSTRACT

Methods of identifying a patient with an increased propensity for a medical condition and implementing a responsive treatment are disclosed herein and include: conducting at least one screening test, patient questionnaire or a combination thereof on a patient to detect at least one symptom, historical patient event or a combination thereof for the detection of the medical condition, determining whether the at least one symptom, historical patient event or a combination thereof is the cause or related to the medical condition, determining whether the patient has or is at higher risk for the medical condition, producing a medical condition wellness regimen or schedule for the patient as a responsive treatment, and implementing the wellness regimen or schedule. Systems of identifying a patient with an increased propensity for a medical condition are also disclosed herein.

This United States Utility Application claims priority to U.S. Provisional Patent Application Ser. No.: 61/696153 filed on Sep. 1, 2012, which is commonly-owned and incorporated herein in its entirety by reference. This application is being filed on the first business day after Sunday, Sep. 1, 2013 and Labor Day—Monday, Sep. 2, 2013.

### FIELD OF THE SUBJECT MATTER

The field of the subject matter is interactive patient and physician systems and their methods of use, specifically including an information exchange and knowledge portal linking patients and physicians for the purpose of measurably improving the medical and economic outcomes of various medical symptoms and conditions, including headaches, diabetes, obesity, depression, anxiety, chronic pain, sleep disorders, memory problems including dementia and mild memory loss, joint problems and pain, arthritis, dizziness, vertigo, gastrointestinal symptoms, chest pain, and other cardiovascular symptoms and disease, urinary problems and others.

### BACKGROUND

There are 60 million chronic headache sufferers in the United States. More than 50% of migraine and cluster headache patients do not have a medical diagnosis, and as a result, receive limited and inadequate care. Only a small percentage of these are actually diagnosed. At the same time, over 80% of adults have searched the internet for help with health issues. The majority of headache sufferers have not been accurately diagnosed or effectively treated. Of those with a diagnosis, studies show that the majority are not optimally treated and would be willing to try some other form of headache therapy. It has been discovered that one of the main impediments to diagnosis, and especially accurate diagnosis with effective treatment, is lack of access to headache specialists due to their small number, long waits to see them, high cost, patient's inadequate insurance and unwillingness to pay cash.

Migraine sufferers generally seek care from primary care providers, internists, ENT doctors, dentists, optometrists, ophthalmologists, or other specialists who may or may not have specific expertise in the area of headaches. Research indicates, that nationwide there are approximately 500,000 primary care physicians and 23,000 neurologists (only about 12,500 of which are in active clinical practice). Moreover, approximately half of all visits to neurologists include complaints of headaches. Headaches are one of the most common complaints in general practice and in emergency rooms (the 5^{th} most common complaint in the emergency room) and are generally viewed as one of the most time-consuming, resource-draining, hard to treat medical problems in primary care. Patients are often disappointed with the care they receive, whether from primary care physicians or neurologists.

There are currently only 420 board certified headache specialists in the United States for these millions of patients, so access to expert-level care is minimal. It is estimated that fewer than 15% of headache patients see a neurologist and fewer that 2% see a headache specialist, whether board certified or not. Most headache patients are cared for on the primary care level, by physicians who have not been trained in optimal headache care. Those primary care physicians have a low threshold for referring difficult headache patients to specialists when their insurance plans permit it. In one large, well known and respected HMO headache patients are not even seen by primary care but referred to an educational program and seen by a nurse practitioner. Therefore, any contemplated system that addresses these issues should provide a “step-edit” between primary care management in a vacuum and referral on to a specialist.

When one reviews the common pain area headache, they will note that over the course of a year, approximately 40 million Americans will experience some type of migraine. Fewer than a third of these migraineurs will see a doctor, even fewer see a neurologist or other specialist, and as noted above, less than 2% get help from a board certified headache specialist. Experts estimate that for migraine headaches alone, aggregate costs are approximately $30 B annually, comprising at least $10 B in direct healthcare costs such as doctor visits, ER visits, diagnostic tests and medications. The remaining indirect costs are attributable to lost individual productivity, absenteeism and other workplace related costs.

In order to improve the medical and economic outcomes of a variety of medical symptoms and conditions, starting with headaches, it would be beneficial to develop an information exchange, along with a knowledge portal, linking patients and their physicians. In some embodiments, contemplated information exchanges and systems would be fully automated. In other embodiments, contemplated information exchanges and systems would be at least partially automated, depending on the specific need and information.

### BRIEF DESCRIPTION OF THE FIGURES

FIG. 1 shows a contemplated system 100 where a patient or physician (not shown) accesses a secure login portal 110 to access either the patient portal 120 or the physician portal 130. The patient or the physician can access the pre-login pages 140 that allow the physician to provide general information and articles or allow the patient to access general information and articles.

FIG. 2 shows a portion of a contemplated system 200 where a patient questionnaire 210 is provided, an analysis component 220 analyzes the symptom data and the recommendation component 230 provides narrative output and/or a recommendation document or information document, as disclosed earlier.

FIG. 3 shows a method 300 of identifying a patient (not shown) with an increased propensity for a medical condition and implementing a response that will help physicians (not shown) and nurses (not shown) be more accurate and better diagnose and treat that condition are disclosed herein and include: conducting 310 at least one screening test, patient questionnaire or a combination thereof on a patient to detect at least one symptom, historical patient event or a combination thereof for the detection of the medical condition, determining 320 whether the at least one symptom, historical patient event or a combination thereof is the cause or related to the medical condition, determining 330 from that information whether the patient has or is at higher risk for the medical condition, producing 340 a medical condition wellness regimen or schedule for the patient as a responsive treatment, and implementing 350 the wellness regimen or schedule.

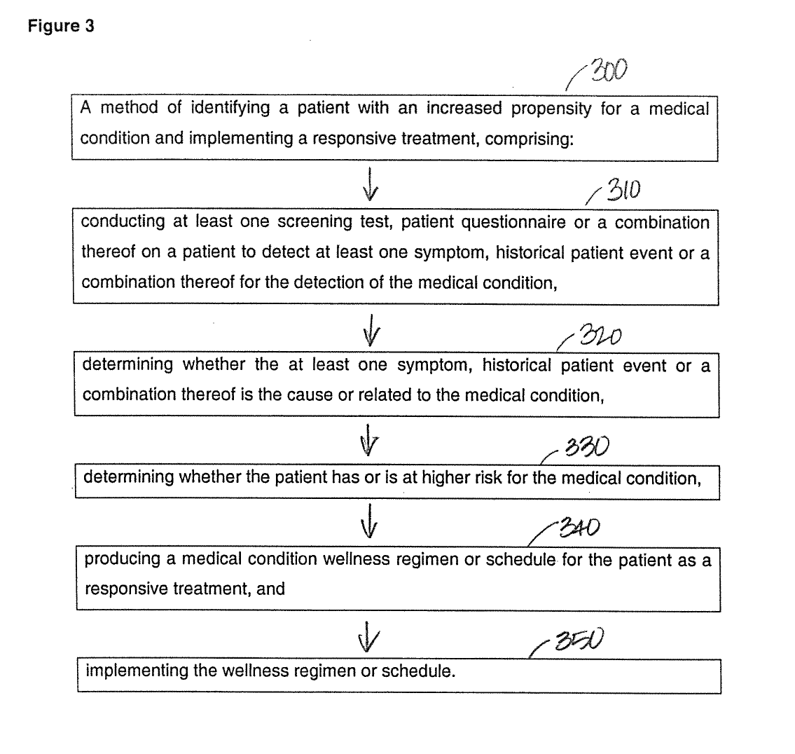

FIG. 4 shows a system 400 for identifying a patient (not shown) with an increased propensity for a medical condition is disclosed that includes: providing an executable code 410 that is stored on a network, a local area network or a combination thereof, wherein the executable code comprises a questionnaire component, an analysis component and a recommendation component or information component, producing 420 a recommendation document or information document that is prepared utilizing the recommendation component or information component, the analysis component or a combination thereof, providing 430 the recommendation document or information document to a medical professional, providing 440 the recommendation document or information document to the patient, coordinating 450 a responsive treatment for the patient, as recommended by the medical professional, and monitoring 460 a responsive treatment for the patient.

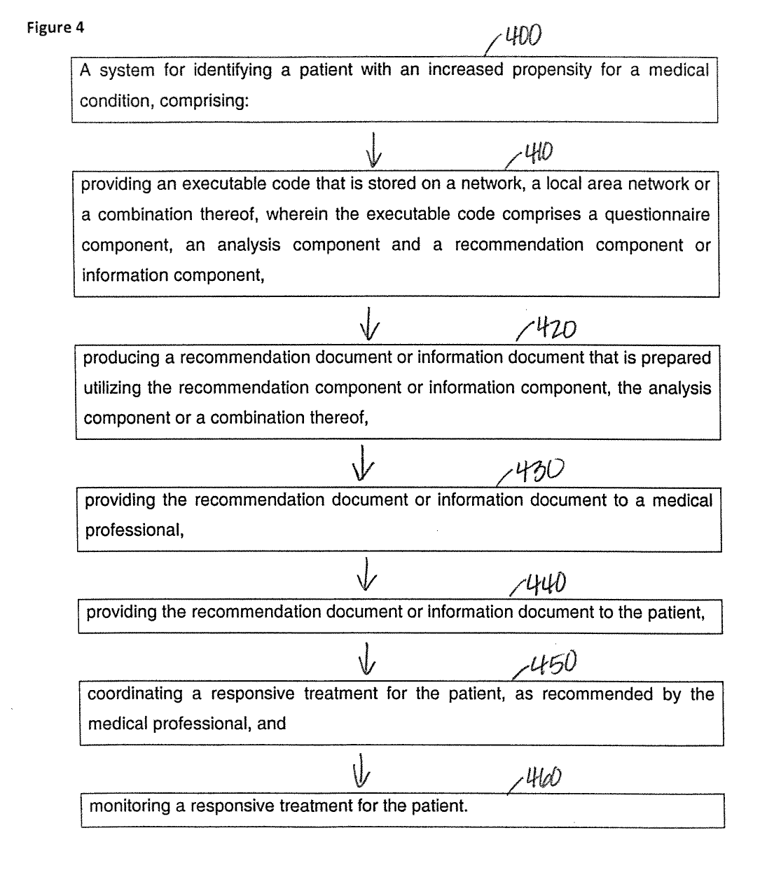

### SUMMARY OF THE SUBJECT MATTER

Methods of identifying a patient with an increased propensity for a medical condition and implementing a response that will help physicians and nurses be more accurate and better diagnose and treat that condition are disclosed herein and include: conducting at least one screening test, patient questionnaire or a combination thereof on a patient to detect at least one symptom, historical patient event or a combination thereof for the detection of the medical condition, determining whether the at least one symptom, historical patient event or a combination thereof is the cause or related to the medical condition, determining from that information whether the patient has or is at higher risk for the medical condition, producing a medical condition wellness regimen or schedule for the patient as a responsive treatment, and implementing the wellness regimen or schedule.

A system for identifying a patient with an increased propensity for a medical condition is disclosed that includes: providing an executable code that is stored on a network, a local area network or a combination thereof, wherein the executable code comprises a questionnaire component, an analysis component and a recommendation component or information component, producing a recommendation document or information document that is prepared utilizing the recommendation component or information component, the analysis component or a combination thereof, providing the recommendation document or information document to a medical professional, providing the recommendation document or information document to the patient, coordinating a responsive treatment for the patient, as recommended by the medical professional, and monitoring a responsive treatment for the patient.

### DETAILED DESCRIPTION

In response to the overwhelming need in the medical field to properly and quickly diagnose the source of headaches, along with other difficult to diagnose symptoms and conditions, methods and systems have been developed that can improve the medical and economic outcomes of a variety of medical symptoms and conditions, starting with headaches. An information exchange has been designed, along with a knowledge portal, linking patients and their physicians. In some embodiments, contemplated information exchanges and systems are fully automated. In other embodiments, contemplated information exchanges and systems are at least partially automated, depending on the specific need and information.

A primary care doctor-patient office visit is generally scheduled for less than 15 minutes, leaving limited time for detailed history taking. Yet an accurate headache diagnosis is based primarily on a detailed history which can take up to 45 minutes to obtain by a board certified headache specialist. Collecting these details via the contemplated system's expert questionnaire and with the patient alone engaging the automated or semi-automated process during their own free time saves physician time and increases the time for doctor-patient discussion and/or improves the physician's diagnostic accuracy and throughput. It also enables the physician to have more data, which will help in arriving at the correct diagnosis. A list of appropriate treatment choices by category, available immediately to the physician on line, will aid the physician in formulating an effective, up to date treatment plan, leaving more time for implementation, education and discussion.

Methods of identifying a patient with an increased propensity for a medical condition and implementing a responsive treatment are disclosed herein and include: conducting at least one screening test, patient questionnaire or a combination thereof on a patient to detect at least one symptom, historical patient event or a combination thereof for the detection of the medical condition, determining whether the at least one symptom, historical patient event or a combination thereof is the cause or related to the medical condition, diagnosing whether the patient has or is at higher risk for the medical condition, producing a medical condition wellness regimen or schedule for the patient as a responsive treatment, and implementing the wellness regimen or schedule.

A system for identifying a patient with an increased propensity for a medical condition is disclosed that includes: providing an executable code that is stored on a network, a local area network or a combination thereof, wherein the executable code comprises a questionnaire component, an analysis component and a recommendation component or information component, producing a recommendation document or information document that is prepared utilizing the recommendation component or information component, the analysis component or a combination thereof, providing the recommendation document or information document to a medical professional, providing the recommendation document or information document to the patient, coordinating a responsive treatment for the patient, as recommended by the medical professional, and monitoring a responsive treatment for the patient.

It is important to note that these contemplated methods and systems are not merely software processes that could have easily been performed by a doctor or another medical professional. It should be clear from the earlier background section that these diagnoses and treatment plans are very difficult to successfully provide, primarily because of the tendency of most non-medical persons to “self-diagnose” or find inadequate information on the internet, coupled with the fact that many people aren't open or complete with their medical history when faced with speaking with a doctor. Although the patient has the time to give this history, the doctor often has neither the time nor the expertise to obtain it. Therefore the patient should spend the time providing the information prior to the office visit and the data should be conveyed to the doctor in a precise, understandable and medical way. Contemplated methods and systems add important steps to the process that doctors who normally engage in mentally when evaluating and treating a patient.

It is important to provide a medically-approved method and system that can meet several goals: a) provide prospective patients and patients with an opportunity to identify all of their symptoms, triggers, lifestyle choices and medical history in the comfort of their own environment, b) allow medical professionals to get a full picture of the scope of the patient's medical issues and history, c) facilitate a proper and complete diagnosis by the medical professional, d) produce a wellness regimen for the patient as a responsive treatment, e) allow for automatic follow-up with the patient, and f) modify the treatment plan and the implementation of the treatment plan as necessary.

Contemplated systems include an informational website on headaches, that amongst other things comprises at least one secure location where patients can complete a HIPAA compliant, detailed questionnaire, screening test or a combination thereof about their medical and, in some embodiments—headache history, as though interacting with a medical and/or headache expert. Contemplated systems and methods are able to detect at least one symptom, at least one historical patient event or a combination thereof for the detection of the medical condition.

A rule-based engine, otherwise referred to as the “analysis component” (developed by authoritative headache and artificial intelligence experts) analyzes the medical data and generates a very complete narrative history, clinical impression and red flags for the physician to be concerned about, in real time. The recommendation component provides the product of this analysis—a letter (recommendation document or information document) to the medical professional—is produced and is downloadable in PDF or possibly Word format for the patient to bring to their primary care physician or specialist. The patient will be able to correct any mistakes in the document and the doctor will be able to add or correct the document further.

A disclaimer informs the patient that only a physician can make a definite diagnosis and order treatment, after appropriate evaluation of the history, conduct a proper examination and arrange for and evaluate the results of appropriate testing. With the patient's permission, the physician may be able to access the questionnaire, download it to the chart and interact with it to see which questions support or do not support the clinical impression. The physician can contemplate the listed red flags and decide whether further evaluation is necessary. After the physician makes a diagnosis, further information about various types of treatment of that diagnostic entity will be available to the patient or physician on the website.

In contemplated methods and systems, determining whether the at least one symptom, historical patient event or a combination thereof is the cause related to the medical condition comprises producing a recommendation document or information document that is prepared utilizing the recommendation component or information component, providing a detailed determination by a medical professional or a combination thereof. The information collected, stored and generated into a downloadable expert letter, recommendation document or information document to a physician, which will save time and expense, improve documentation in the chart, all the while delivering a higher level of evaluation and care to individuals with various medical symptoms and conditions, including headaches, diabetes, obesity, depression, anxiety, chronic pain, sleep disorders, memory problems including dementia and mild memory loss, joint problems and pain, arthritis, dizziness, vertigo, gastrointestinal symptoms, chest pain, and other cardiovascular symptoms and disease, urinary problems and others.

Contemplated embodiments provide a new paradigm in diagnostic and therapeutic tools: automated or semi-automated suggestions of possible clinical impressions for physicians to consider in their diagnoses and the ability for physicians to easily look up specific therapies adds targeted information to the physician's own history, examination and appropriate testing to improve the accuracy of their diagnoses, and optimize their treatment plan and medical outcome. Contemplated embodiments are interactive internet-based, downloadable client applications with a secure neutral content exchange that is coupled with information portals, and requires no hardware or software investment from its various users. Training is negligible and there are carefully written instructions as well as short instructional videos on the site.

Contemplated embodiments provide interaction with an innovative, state of the art, client-based questionnaire designed by medical experts and programmers skilled in artificial intelligence, on which patients answer detailed queries about their present illness and many other relevant aspects of their history. The questions and system of recording responses are designed for quick, easy, yet highly accurate collection of the type of information that most physicians would either not know to seek and/or would not have the time to acquire during a typical, time-limited, patient interaction. Patients may save their completed work and leave the questionnaire to return later at their leisure if they are unable to complete it in one sitting. The output is in the form of a physician narrative, formatted like an expert consultative report, in short easily readable paragraphs, including bulleted highlights and red flags suggesting areas of immediate concern to the physician. In some contemplated embodiments, the report explicitly states that the document is not intended to replace a clinician's history or final diagnosis but will serve as a powerful tool for the patient's primary care physician or specialist to use in reaching a diagnosis and treatment plan. These contemplated methods and systems aren't merely taking one form of information and representing it in another form, but instead is taking large amounts of patient information, analyzing it, and providing a comprehensive history, clinical impressions with best fit scenarios based on patient history and warnings or red flags to the patient and physician. It is one step in the overall method or system that is contemplated herein.

Both the patient and physician can access and review the most likely clinical impression based on the patient's inputted specific history, which the physician can confirm or alter based on further history, physical and neurological examination and/or appropriate laboratory testing. The physician can also view a drop-down menu offering specific subsets of answers to questions that either support or refute the clinical impression offered in the report. A list of red flags warns the physician of possible secondary causes of headache that could prompt more extensive testing or consultations. The physician and the patient can access the treatment section of the website, check any one of a large number of diagnoses, and find a description of a typical patient with that condition, and behavioral treatment suggestions, acute treatment suggestions and preventive suggestions for that diagnosis.

Enhanced data efficiency and ease of documentation provided by contemplated embodiments permits higher service levels within a greatly reduced timeframe at significantly lower cost to patient and payer. Increased patient throughput and reduced diagnostic time allows doctors to increase their billable hours while reducing the number of unbilled hours due to fact finding, research and consultation. The computerized reports and clinical impressions that are generated by contemplated systems and embodiments are easily transferrable to electronic medical records (EMR), further saving the physician time and possibly allowing for a higher billing code level due to the comprehensive nature of the report. The report output from contemplated embodiments will be compatible with one or more frequently used EMR systems to make physician report production effortless. This will mean that most physicans will not have to dictate or type their reports, saving 5-15 minutes per patient, or more.

The patient follows clear, brief, prompts on easy-on-the-eyes graphically designed pages to document all details of their history in a highly structured fashion at their leisure, using any computer with web-access. There is only one question per screen and an automatic advancement to the next question. In many areas the patient is able to expand on the multiple choice answers by typing in their own responses. The server-based rules engine utilized in contemplated embodiments uses the data to produce a sophisticated, detailed but brief, well organized and to the point medical history in the form of a bulleted narrative report, accompanied by an appropriate clinical impression and red flags. The report also included detailed information on current and previous medication and other forms of treatment as well as previous testing and results.

As disclosed herein, the inherent benefits of contemplated systems include providing a complete web-delivered solution that connects patients and their physicians with a knowledge pool of specialty medical intelligence concerning various specific conditions. The process begins with a web-based, easy to follow, self-guided interface on which patients input an accurate medical history via a validated questionnaire designed and built by accredited and recognized expert clinicians in conjunction with expert computer scientists specializing in artificial intelligence. Historical data are processed through a rules-based analytics engine. Then clinical impressions and red flags are downloaded by the patient and either sent electronically or brought in printed form to the patient's primary care physician or specialist for consideration and evaluation. In many cases, when the patient is seeing only a primary care physician, this will eliminate the need for expensive and time-consuming referrals to specialists. In most cases this will expedite, streamline, and improve the accuracy of today's inefficient, unreliable and costly information exchange between doctor and patient. The offering includes interactive patient data capture with automated drop-down alternatives to choose from based on relevant data entered, multi-tiered expert-derived evaluation, scalable and reliable technology, an on-line store of helpful, hard-to-find books and treatment items, applications (apps) for smart phones so patients can record daily symptoms and results of treatment and obtain automated feedback for them and their physicians about their progress.

Also, as mentioned earlier, contemplated systems are designed to reduce the costs and time associated with headache relief. In the US, patients with headaches spend an estimated $2-3 billion annually for consultation, root cause isolation and diagnosis on their path to effective therapy and recovery. Experts agree that over 12% of the adult population in the US, which translates to approximately 36 million adults, suffer from migraine, causing incapacitating throbbing headache, nausea, vomiting, light and sound sensitivity, inability to move without incurring more pain, and often many hours of disability and decreased quality of life. 75% of the migraine population is women between 12 and 50 years of age. This figure does not include many children under the age of 12 who also suffer from migraine and other severe headache. There are approximately 25-30 million additional adults, who suffer from chronic headaches other than migraine. It is generally believed the overall headache population is significantly greater than that stated above because men often do not readily seek medical consultation for headaches and many are not counted as they are unable to see a doctor or get good medical care.

In addition to the history, diagnostic, and treatment tools, some contemplated embodiments may offer specialized items related to specific health issues through an online store and authoritative educational materials in the form of static pages, books, videos, apps and various social networking tools. A specific social network for patients of this net-based system will be formed for discussion, at times led by authoritative specialists.

Contemplated embodiments and related services provide many advantages and benefits, including reducing the patient's need to visit multiple doctors, no charges to the patient for the history, and minimal charges in the form of upgrades to a high level of reporting available to them and their physician. In addition, by reducing the number of ineffective and unnecessary same patient, same illness diagnostic evaluations and physician visits, payor systems will appreciate significant savings. HMOs such as Kaiser Permanente should be interested in supplying this system to all its primary care physicians and certain specialists, as it represent a significant savings in time and money over the fees charged by specialists for consultation. Contemplated systems give these HMO physicians the ability to evaluate and care for headache patients at a higher level more quickly and with better documentation. Holding down neurologic evaluations should produce a big cost savings in a closed system HMO. Private insurers, such as United Health Care, should be interested in offering this system to patients who are not doing well and costing the system too much, and also to primary care physicians and physician extenders/midlevels to help them to be more diagnostically accurate, productive, efficient and therapeutically effective. Physicians who appreciate the improved patient data transfer with resultant time saving that will minimize non-billable case research time will encourage patients and payers to use contemplated systems. It is likely that most headache specialists and many neurologists will ask their patients to use contemplated systems prior to their initial evaluation, which will save time, increase accuracy and improve efficiency while adding critical information to the electronic or paper record, without expending doctor or office staff time. This may also improve physician reimbursement due to the higher level of evaluation with little increase in physician time. The ACA will probably cause new medical groups under insurers to be greatly concerned about cost and outcome and the systems described above are exactly what will help them stay ahead of the curve.

As contemplated herein, at least part of the contemplated methods and systems may utilize, access and/or store information on at least one shared network infrastructure. Contemplated shared network infrastructures include the internet or a web service, the Cloud, a network structure, a grid-computing system, a mainframe computer system, a utility computing system, a peer-to-peer architecture system or a combination thereof. As contemplated herein, executable codes are stored on a network, local area network or a combination thereof, so that the code can be accessed and executed by the computer system or device. Contemplated executable codes may also be in the form of an “app” or “application” that is stored on a smartphone or handheld device.

### EXAMPLE

### Contemplated System Schematics and Structure

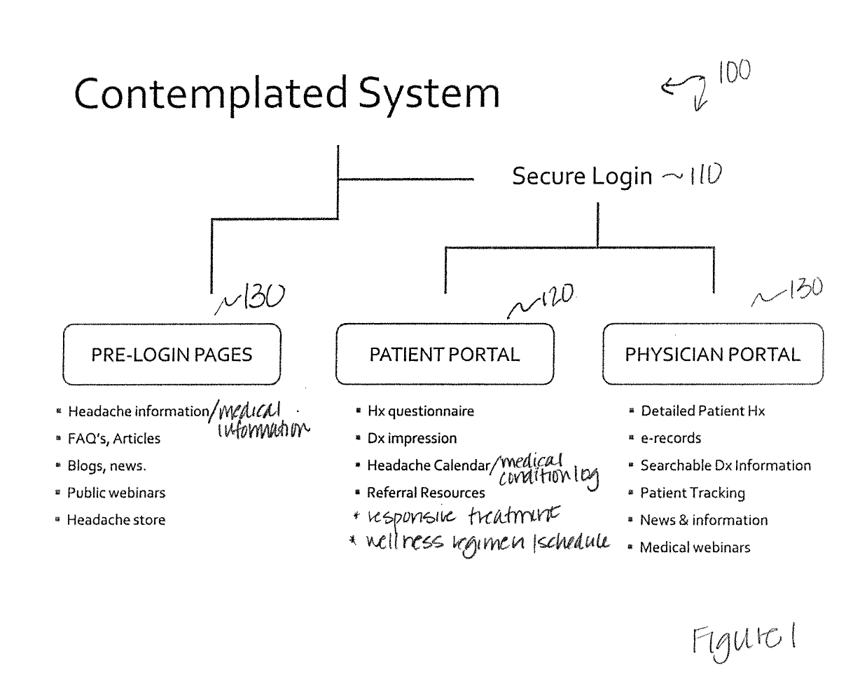

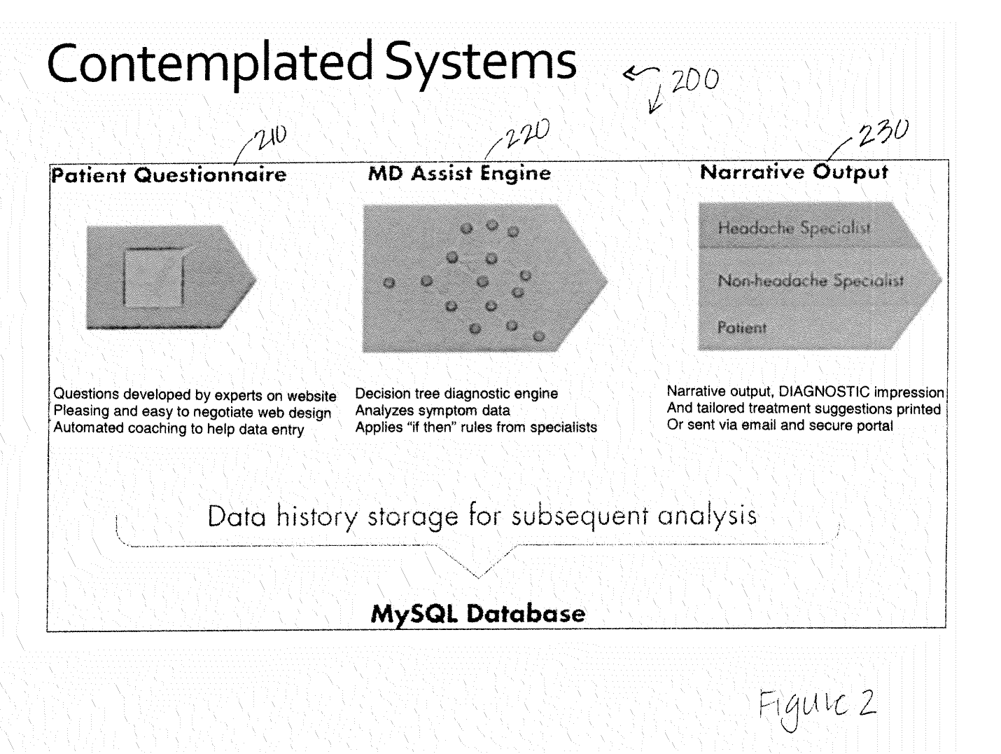

FIGS. 1 and 2 provides one embodiment of a contemplated basic schematic and general system design. FIG. 1 shows a contemplated system 100 where a patient or physician (not shown) accesses a secure login portal 110 to access either the patient portal 120 or the physician portal 130. The patient or the physician can access the pre-login pages 140 that allow the physician to provide general information and articles or allow the patient to access general information and articles. The pre-login pages 140 and patient portal 120 may be accessible through a mobile app as well. FIG. 2 shows a portion of a contemplated system 200 where a patient questionnaire 210 is provided, an analysis component 220 analyzes the symptom data and the recommendation component 230 provides narrative output and/or a recommendation document or information document, as disclosed earlier.

The service-based, server-side architecture means that all operations are guaranteed to be secure and that all call and telemarketing data can be backed up and maintained with extreme reliability and efficiency.

Contemplated embodiments may reside or be stored on central, carefully monitored and protected, secure servers and/or on the cloud. The application is maintained on these web servers and the patient letter is downloaded only after proper credentialing and verification of the patient. Once downloaded, the letter can be taken or electronically sent to any physician or kept for the patient's own information. All the data is free of identifiers and HIPAA compliant.

A contemplated system provides for easy data entry, helps to ensure the stream of medical questions and answers are consistent and produce an output for the Headache Specialist, Neurologist or primary care physician. For this example, Robala has developed a proprietary inference engine to be used in conjunction with data capture. Prior to data entry, the patient will choose a unique password and user name. The questionnaire is then answered and saved in the Robala database. This interaction between the client and the database occurs through an encrypted Transport Layer Security (TLS) or Secure Socket Layer (SSL).

The application services access a MySQL database for data history storage and subsequent analysis in the aggregate. The choice of MySQL balances cost with performance. MySQL is open sourced software that is capable of satisfying the most demanding transactions and integration needs. Contemplated embodiments can provide a rich suite of services such as enterprise application integration, intelligent data management and mining, streaming media etc.

The history, narrative and clinical impression tool have been designed to run on the secure server.

Thus, specific embodiments, methods of interactive patient and physician systems and their methods of use, specifically including an information exchange and knowledge portal linking patients and physicians for the purpose of measurably improving the medical and economic outcomes of various medical symptoms and conditions, including headaches, diabetes, obesity, depression, anxiety, chronic pain, sleep disorders, memory problems including dementia and mild memory loss, joint problems and pain, arthritis, dizziness, vertigo, gastrointestinal symptoms, chest pain, and other cardiovascular symptoms and disease, urinary problems and others have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A method of identifying a patient with an increased propensity for a medical condition and implementing a responsive treatment, comprising:
conducting at least one screening test, patient questionnaire or a combination thereof on a patient to detect at least one symptom, historical patient event or a combination thereof for the detection of the medical condition,
determining whether the at least one symptom, historical patient event or a combination thereof is the cause or related to the medical condition,
determining whether the patient has or is at higher risk for the medical condition,
producing a medical condition wellness regimen or schedule for the patient as a responsive treatment, and
implementing the wellness regimen or schedule.

2. The method of claim 1, wherein the medical condition comprises headaches, diabetes, obesity, depression, anxiety, chronic pain, sleep disorders, memory problems including dementia and mild memory loss, joint problems and pain, arthritis, dizziness, vertigo, gastrointestinal symptoms, chest pain, cardiovascular symptoms and disease, urinary problems or a combination thereof.

3. The method of claim 2, wherein the medical condition comprises a headache.

4. The method of claim 1, wherein determining comprises producing a recommendation document or information document that is prepared utilizing the recommendation component or information component, providing a detailed determination by a medical professional or a combination thereof.

5. The method of claim 1, wherein the conducting step is automated or semi-automated.

6. A system for identifying a patient with an increased propensity for a medical condition, comprising:
providing an executable code that is stored on a network, a local area network or a combination thereof, wherein the executable code comprises a questionnaire component, an analysis component and a recommendation component or information component,
producing a recommendation document or information document that is prepared utilizing the recommendation component or information component, the analysis component or a combination thereof,
providing the recommendation document or information document to a medical professional,
providing the recommendation document or information document to the patient,
coordinating a responsive treatment for the patient, as recommended by the medical professional, and
monitoring a responsive treatment for the patient.

7. The system of claim 6, wherein the medical condition comprises headaches, diabetes, obesity, depression, anxiety, chronic pain, sleep disorders, memory problems including dementia and mild memory loss, joint problems and pain, arthritis, dizziness, vertigo, gastrointestinal symptoms, chest pain, cardiovascular symptoms and disease, urinary problems or a combination thereof.

8. The system of claim 7, wherein the medical condition comprises a headache.

9. The system of claim 6, wherein the producing a recommendation document or information document step, the providing the recommendation document or information document step or a combination thereof is automated or semi-automated.

10. The system of claim 6, wherein the executable code is stored on a computer or a handheld device.

11. The system of claim 6, wherein the recommendation document is sent electronically to the patient, the physician or a combination thereof.
